(19) United States
(12) Patent Application Publication
(10) Pub. No.: US 2026/0237152 A1
(43) Pub. Date: Aug. 13, 2026

(54) 3D MODEL TIMELINES RECONSTRUCTION

(71) Applicant: State Farm Mutual Automobile Insurance Company, Bloomington, IL (US)

(72) Inventor: Alex James O'Neill, Phoenix, AZ (US)

(73) Assignee: State Farm Mutual Automobile Insurance Company, Bloomington, IL (US)

(21) Appl. No.: 19/048,293

(22) Filed: Feb. 7, 2025

(51) Int. Cl. G06T 17/00

(52) U.S. Cl. CPC G06T 17/00; G06T 2200/08; G06T 2200/24

(57) ABSTRACT

Systems, devices, and methods for reconstruction of an event are disclosed. The timeline reconstruction may include gathering data associated with an event, analyzing the data, generating a 3D visualization of the event and surrounding environment, and generating a timeline for the event that allows a user to see probable start and end points of the event. The 3D timeline reconstruction may include tools to allow a user to vary parameters in the timeline reconstruction to see how the changed parameters vary start and end points.

### TECHNICAL FIELD

This present disclosure relates generally to the timeline reconstruction of an event. In particular, the present disclosure relates to various embodiments for generating a three-dimensional (3D) environment of an event and a reconstructing a timeline for occurrences during the event over time.

### BACKGROUND

High quality event reconstruction of an event may be desired for many reasons, such as educational purposes, law enforcement, litigation, insurance inquiries, entertainment purposes, scientific research, as well as many other reasons. Gathering data for such a reconstruction can take many forms, which may ultimately be used to provide imagery of an event that allows a user to see an event at different times. In some cases, a user may be able to view the event over time or even from different perspectives. However, the process of compiling visual data into an event reconstruction can present a number of technical challenges. For example, existing systems may have trouble using existing data to produce a visualization that is easily understood by a user. Further, available data of an event may be limited by quantity, quality, and number of sources. Even in the case that a large amount of data is available for event reconstruction, existing systems are not configured to view different outcomes based on variables in the data, which may require a user to guess at likely outcomes based on the provided data. The lack of predictive capabilities may make it difficult for conventional systems to produce alternative starting points or outcomes an event. Additionally, traditional systems may struggle to use data from some types of data sources including written reports, environmental factors, or complex visual data. Without the adaptability offered by machine-learning techniques, conventional approaches may remain hard to understand, static, and ineffective in addressing the evolving complexities of event reconstruction.

Therefore, needs exist for high quality event reconstruction accommodating diverse data sources and producing visualizations that are easily understood and take into account a wide range of possible starting points and outcomes.

### SUMMARY

The present embodiments may relate, inter alia, to methods, devices, and systems for timeline reconstruction of an event. Specifically, the present computer systems and computer-implemented methods may solve technical challenges by leveraging advanced machine-learning models and data aggregation techniques to dynamically analyze aspects of an event and provide a 3D visualization of the event reconstruction of the user. By integrating diverse data sources, the system may generate actionable insights and allow users to view unexpected aspects of an event. This approach may overcome the limitations of static event reconstruction systems by utilizing data from many different sources as well as using predictive algorithms and dynamic modeling to visualize alternative starting and endpoints of an event, thereby providing a more useful and powerful timeline reconstruction.

In one aspect, a computer-implemented method for reconstructing the timeline of an event is provided, the computer-implemented method including: receiving, by the one or more processors, input data of an event from one or more external devices, the event including a subject in an environment; analyzing, by the one or more processors, the input data of the event including extracting metadata relating to the event from the input data; generating, by the one or more processors, a generic 3D model including the subject and the environment; adding, by the one or more processors, rendering data and a rules engine to the generic 3D model to generate a detailed 3D model, the rendering data based on the extracted metadata related to the event; and generating, by the one or more processors, a timeline reconstruction of the event within the detailed 3D model, the timeline reconstruction comprising at least a first state of the subject within the environment at a first time and a second state of the subject within the environment at a second time, wherein the first time is different than the first time.

The computer-implemented method may further include: providing, by the one or more processors, a timeline reconstruction replay tool to a user, wherein the timeline reconstruction replay tool is configured to display: the first state of the subject within the environment in the detailed 3D model at the first time period, the second state of the subject within the environment in the detailed 3D model at the second time period, and a transition period visually depicting a change between the first state at the first time period and the second state at the second time period.

In some implementations, the timeline reconstruction further comprises a third state of the subject within the environment at the second time. The method may also include: providing, by the one or more processors, a timeline reconstruction replay tool to a user, wherein the timeline reconstruction replay tool is configured to display: the first state of the subject within the environment in the detailed 3D model at the first time period, the second state of the subject within the environment in the detailed 3D model at the second time period, the third state of the subject within the environment in the detailed 3D model at the second time period, a first transition period visually depicting a first transition period visually depicting a change between the first state at the first time period and the second state at the second time period, and a second transition period visually depicting a first transition period visually depicting a change between the first state at the first time period and the third state at the second time period.

In some implementations, the timeline reconstruction replay tool is further configured to display a first confidence score for the second state and a second confidence score for the third state. The timeline reconstruction replay tool may further includes a variable input tool, the variable input tool configured to receive data for at least one parameter of the event and adjust the detailed 3D model based on the at least one parameter. The input data of the event may include one or more photos, video clips, verbal description, written reports, or 3D model data. The input data may include one or more of lighting data, weather data, or traffic congestion data.

In another aspect, a computer system for visualizing an event timeline is provided, the computer system comprising: a memory having processor-readable instructions stored therein; and one or more processors configured to access the memory and execute the processor-readable instructions, which when executed by the one or more processors configures the one or more processors to perform a plurality of functions, including functions for: receiving input data of the event with a subject from one or more external devices; generating a 3D model based on the received input data including the subject and the environment; generating a timeline of the event within the 3D model, the timeline comprising a first time and a second time; and a display device configured to display the 3D model, the timeline with the first time and the second time, and a tool for selecting a third time between the first time and the second time.

In some implementations, the display device is further configured to display a confidence score based on a likelihood that the second time shows correct data. The display device may be further configured to display a variable input tool, the variable input tool configured to receive data for at least one parameter of the event and adjust the detailed 3D model based on the at least one parameter.

In yet another aspect, a non-transitory computer-readable medium containing instructions for reconstructing the timeline of an event is provided, the instructions comprising: receiving, by the one or more processors, input data of the event from one or more external devices, the event including a subject in an environment; extracting, by the one or more processors, metadata relating to the event from the input data; generating, by the one or more processors, a generic 3D model including the subject and the environment; adding, by the one or more processors, rendering data and a rules engine to the generic 3D model to generate a detailed 3D model, the rendering data based on the extracted metadata related to the event; generating, by the one or more processors, a timeline reconstruction of the event within the detailed 3D model, the timeline reconstruction comprising at least a first state of the subject within the environment at a first time and a second state of the subject within the environment at a second time, wherein the first time is different than the first time; and outputting, by the one or more processors, the timeline reconstruction of the event within the detailed 3D model to a user interface of a user device.

In some implementations, the instructions include: displaying, by the one or more processors, a timeline reconstruction replay tool to the user device, the timeline reconstruction replay tool configured to display: a first state of the subject within the environment in the detailed 3D model at the first time period, a second state of the subject within the environment in the detailed 3D model at the second time period, and a transition period visually depicting a change between the first state at the first time period and the second state at the second time period. The timeline reconstruction further may also include a third state of the subject within the environment at the second time.

In some implementations, the instructions include displaying, by the one or more processors, a timeline reconstruction replay tool to the user device, the timeline reconstruction replay tool configured to display: the first state of the subject within the environment in the detailed 3D model at the first time period, the second state of the subject within the environment in the detailed 3D model at the second time period, the third state of the subject within the environment in the detailed 3D model at the second time period, a first transition period visually depicting a first transition period visually depicting a change between the first state at the first time period and the second state at the second time period, and a second transition period visually depicting a first transition period visually depicting a change between the first state at the first time period and the third state at the second time period.

In some implementations, the timeline reconstruction replay tool is further configured to display a first confidence score for the second state and a second confidence score for the third state. The timeline reconstruction replay tool may also include a variable input tool, the variable input tool configured to receive data for at least one parameter of the event and adjust the detailed 3D model based on the at least one parameter. The input data of the event may include one or more photos, video clips, verbal description, written reports, or 3D model data. The input data may include one or more of lighting data, weather data, or traffic congestion data. The computer system may also display, by the one or more processors, a subject edit tool to the user device, wherein the subject edit tool is configured to edit the position of the subject within the detailed 3D model.

The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram showing an exemplary computing system for generating a 3D event timeline reconstruction, according to certain aspects of the disclosure.

FIG. 2 is a diagram showing an exemplary system for gathering data for a 3D event timeline reconstruction, according to certain aspects of the disclosure.

FIG. 3 is a diagram showing an exemplary system for analyzing data for a 3D event timeline reconstruction, according to certain aspects of the disclosure.

FIG. 4 is a diagram showing an exemplary 3D event timeline reconstruction system with different possible starting points, according to certain aspects of the disclosure.

FIG. 5 is a diagram showing an exemplary 3D event timeline reconstruction system with tools for modification, according to certain aspects of the disclosure.

FIG. 6 is a flowchart showing an exemplary method for generating a 3D event timeline reconstruction, according to certain aspects of the disclosure.

Advantages will become more apparent to those skilled in the art from the following description of the preferred embodiments that have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods for generating a reconstruction of an event timeline. In some implementations, the reconstruction is provided in a 3D visualization generated by compiling data from the event that allows a user to replay the event from possible starting points for a visual explanation of an event. The visualization may also allow a user to change variables in the timeline to view different outcomes and starting points.

Current methods of timeline reconstruction may rely heavily on human reasoning and may be limited by human experiences. Recent advances in technologies can assist with reasoning about a given situation, and allow for the integration of more data surrounding an event. Existing systems may also be limited by data that can be collected for a certain event. Often, this data may be insufficient for a conventional 3D visualization and may not take into account the proximities of various circumstances during the event.

Conventional approaches may be technically challenged regarding incorporating advanced analytics or predictive modeling, making it difficult to understand the probability of events or forecast starting points for any given event. This lack of adaptability may lead to generalized timeline visualization that may overlook unexpected variables. Furthermore, conventional systems may lack the technical capability to integrate machine-learning models for dynamically adjusting visualizations as new data becomes available, resulting in static systems that are unable to adapt.

### EXEMPLARY COMPUTING SYSTEM

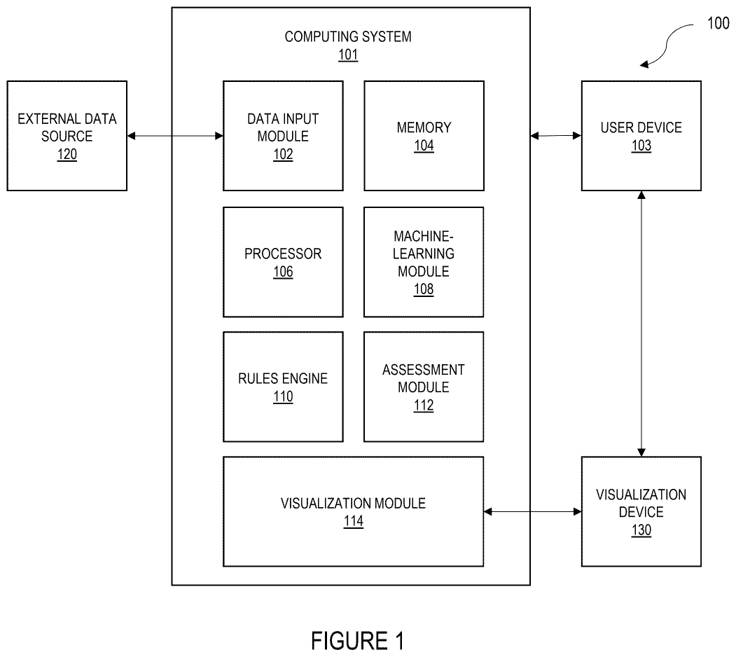

To address technical challenges, such as the above, the event timeline reconstruction system includes the computing system 101 of FIG. 1 that may leverage advanced machine-learning algorithms to generate timeline reconstructions of events. Unlike traditional systems, which may rely upon static assessment and processing limited types of data, the computing system 101 may utilize a data-driven approach that is capable of processing many types of data and integrating machine learning to provide a complete reconstruction that is easily visualized and modified by a user.

FIG. 1 illustrates an implementation of a computing system 101 that may execute the techniques presented herein. The computing system 101 may include a set of instructions that can be executed to cause the computing system 101 to perform any one or more of the methods or computer based functions disclosed herein. The computing system 101 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computing system 101 may operate in the capacity of a server or as a client user computer in a server-client user network environment, or as a peer computer system in a peer-to-peer (or distributed) network environment. The computing system 101 can also be implemented as, or incorporated into, various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computing system 101 may be implemented using electronic devices that provide voice, video, or data communication. Further, while the computing system 101 is illustrated as a single system, the term “system” shall also be taken to include any collection of systems or sub-systems that individually or jointly execute a set, or multiple sets, of instructions to perform one or more computer functions.

FIG. 1 depicts a diagram showing an exemplary timeline reconstruction system 100 including a computing system 101 that receives data related to an event, processes this data to reconstruct a timeline of the event, predict possible starting or end points of the reconstruction, and display a visualization of the timeline construction to a user. FIG. 1 depicts a computing system 101 that may include a data input module 102, memory 104, a processor 106, a machine-learning module 108, a rules engine 110, an assessment module 112, and a visualization module 114. It should be understood that other implementations of computing system 100 may omit one or more of the foregoing components and/or may include additional components, as the case may be. As used herein, terms such as “component” or “module” generally encompass hardware and/or software, e.g., that a processor or the like used to implement associated functionality. It is contemplated that the functions of these components are combined in one or more components or performed by other components of equivalent functionality.

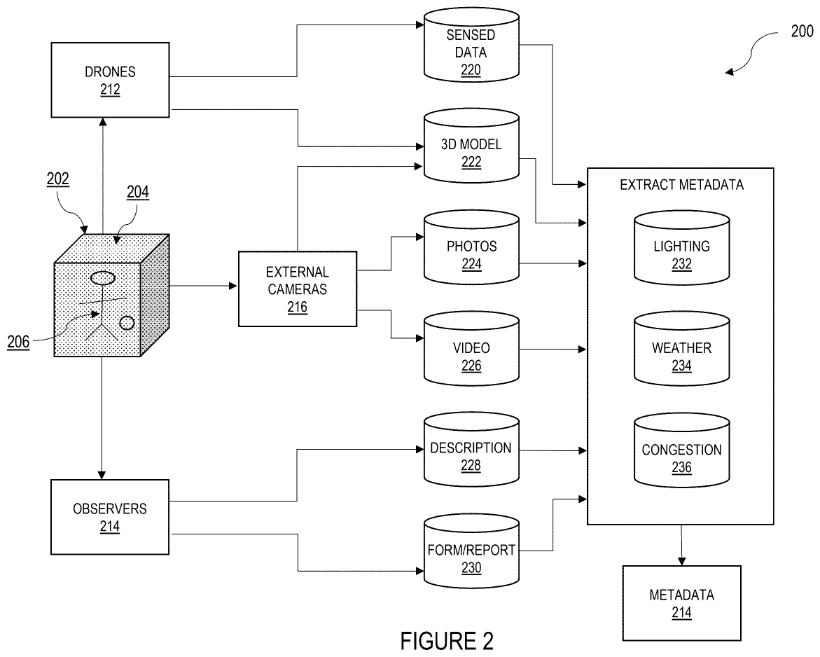

In some implementations, the computing system 101 may receive with a data input module 102, real-time or recorded data related to an event from an external data source 120. This data can take many forms (as discussed further in the description of FIG. 2) including sensor data, 3D modeling data, photos, video, written or verbal descriptions, or data from a form or report. The external data source 120 may also include many different types of devices, including cellphone cameras, traffic cameras, security cameras, weather sensors, vehicle sensors, databases, reports, interviews, statements, and combinations of these data sources. The data input module 102 may integrate the collected data into a unified framework and may perform a data normalization process to ensure compatibility across various formats and sources. This robust data foundation may facilitate advanced analytics and machine-learning algorithms to generate timeline reconstruction of the event in a 3D environment.

In some implementations, the computing system 101 includes a processor 106 and memory 104. In general, any process or operation discussed in this disclosure is understood to be computer-implementable, such as the processes illustrated in FIGS. 2-6 which may be performed by one or more processors of a computer system as described herein. A process or process action or operation performed by one or more processors may also be referred to as an operation. The one or more processors 106 may be configured to perform such processes by having access to instructions (e.g., software or computer-readable code) that, when executed by one or more processors, cause the one or more processors to perform the processes. The instructions may be stored in a memory 104 of the computer system. A processor 106 may be a central processing unit (CPU), a graphics processing unit (GPU), or any suitable type of processing unit. One or more processors of a computer system may be included in a single computing device or distributed among a plurality of computing devices. The processor 106 may be a component in a variety of systems. For example, the processor 106 may be part of a standard personal computer or a workstation. The processor 106 may be one or more processors, digital signal processors, application specific integrated circuits, field programmable gate arrays, servers, networks, digital circuits, analog circuits, combinations thereof, or other now known or later developed devices for analyzing and processing data. The processor 106 may implement a software program, such as code generated manually (i.e., programmed).

The processor 106 may be connected to a memory 104, which may be a data storage device. A memory 104 of the computer system may include the respective memory of each computing device of the plurality of computing devices. The memory 104 may be a main memory, a static memory, or a dynamic memory. The memory 104 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 104 may include a cache or random-access memory for the processor 106. In alternative implementations, the memory 104 is separate from the processor 106, such as a cache memory of a processor, the system memory, or other memory.

The memory 104 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 104 is operable to store instructions executable by the processor 106. The functions, acts or tasks illustrated in the figures or described herein may be performed by the processor 106 executing the instructions stored in the memory 104. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some implementations, the computing system 101 may include a machine-learning module 108. This module 108 may be configured for integrating artificial intelligence into the generation of the timeline reconstructions. For example, the machine-learning module 108 may provide supervised machine-learning and utilize training data. The trained model may be configured to predict possible outcomes or starting points on the timeline, predict missing input data for an event, and make changes in a reconstruction timeline according to different variables. In one example, the machine-learning module 108 may perform model training using training data (e.g., data from other modules, which contain input and correct output, to allow the model to learn over time). The training may performed based upon the deviation of a processed result from a documented result when the inputs are fed into the machine-learning model (e.g., an algorithm may measure its accuracy through the loss function, adjusting until the error has been sufficiently minimized). The machine-learning module 108 may randomize the ordering of the training data, visualize the training data to identify relevant relationships between different variables, identify any data imbalances, and split the training data into two parts, where one part may be for training a model and the other part may be for validating the trained model, de-duplicating, normalizing, correcting errors in the training data, and so on.

In one instance, the machine-learning module 108 may be trained upon diverse input datasets for an event, such as historical data, weather data, and sensor data. The machine-learning module 108 may analyze historical data, real-time data, and/or attributes associated with the event to categorize the input data, such as by visual data, audio data, and descriptive data. The machine-learning module 108 may evaluate the quality of event data to determine where data is missing. For example, the machine-learning module 108 may analyze visual data collected from cameras of a traffic intersection during an accident, and may determine that a certain portion of the intersection was not sufficiently covered by the available camera data. The machine-learning module 108 may flag the missing data and generate an extrapolated data set for the missing camera data based on the available camera data. The machine-learning module 108 may also be configured to trim unlikely scenarios or frames from the timeline reconstruction.

In some implementations, the machine-learning module 108 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like. The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In some implementations, the computing system 101 includes a rules engine 110. The rules engine 110 may be configured to add a set of rules to the timeline reconstruction. For example, the computing system may generate a timeline reconstruction of a batter hitting a baseball. The rules engine 110 may be used to add physics rules to the timeline reconstruction, such that Newtonian physics apply to all timeline events. The rules engine 110 may be used flag and/or replace extraneous data (such as an anomalous sensor readings of a the motion of the baseball) within a timeline reconstruction.

In some implementations, the computing system 101 includes an assessment module 112. The assessment module 112 may be configured to evaluate the reliability of aspects of the event timeline reconstruction. For example, the computing system 101 may be used to generate a timeline reconstruction with a stationary car with a flat tire at the end of the timeline. The assessment module 112 may assess the timeline reconstruction to generate a probability that the tire was punctured during a car trip, as well as a probability that the tire went flat as a result of the car being parked for an extended period of time. These probabilities may be shown visually to a user, such as on the visualization device 130. The assessment module 112 may also compare the possibilities of different variables, which were generated by the machine-learning module 108, to produce a most likely scenario for a given timeline reconstruction. The assessment module 112 may also be used to generate a score for aspects of a timeline reconstruction using a scoring algorithm that may evaluate parameters such as the quality of data, the likelihood than an event occurred, the similarity between the event and other events, or the accuracy of timing during the timeline reconstruction. These scores may be used to rank outcomes or starting points of the reconstruction timeline, as well as to give an overall score of the quality of the timeline reconstruction. For example, for the above example, the probability that the car tire was punctured during a car trip may be assigned a score of 80, where the probability that the car tire went flat as a result of the car being parked for an extended period of time may be assigned a score of 20, meaning that the punctured tire scenario is much more likely. The overall timeline reconstruction may be given a confidence score of 60, meaning that other reasons for the tire going flat may exist due to missing data.

In some implementations, the computing system 101 includes a visualization module 114. The visualization module 114 may be used to generate a detailed 3D environment for the timeline reconstruction. In some implementations, this visualization is generated by adding metadata from the input data to a generic 3D model. The resulting module 114 may include realistic details to aid a user in understanding the event, such as including realistic lighting, weather details, textures, labeled objects, etc. The visualization module 114 may output the generated visualization to a visualization device 130 that is viewable by a user. The visualization device 130 may be any type of device having a screen suitable for displaying the visualization, such as a computer, tablet, cellphone, television, security system, and other devices. In some cases, the timeline reconstruction visualization may be sent directly to a user device 103. In other cases, some aspects of the visualization are shown on the visualization device 130 such as basic information of the environment of an event, while other aspects of the visualization are shown directly on the user device 103, such as detailed data related to the subject of the event.

In some implementations, the user device 103 may include, but is not restricted to, any type of mobile terminal, wireless terminal, fixed terminal, or portable terminal. Examples of the user device 103 may include hand-held computers, desktop computers, laptop computers, wireless communication devices, cell phones, smartphones, mobile communications devices, a Personal Communication System (PCS) device, tablets, server computers, gateway computers, or any combination thereof, including the accessories and peripherals of these devices, or any combination thereof. In one example, users may utilize the user device 103 to view a visualization of the timeline reconstruction of the event, make updates to the visualization, and view the impact of changing variables in the timeline reconstruction.

### EXEMPLARY EVENT TIMELINE RECONSTRUCTION

FIG. 2 depicts a diagram showing the gathering of data 200 for the 3D timeline reconstruction system 100. These aspects may be carried out by the timeline reconstruction system 100 and computing system 101 shown in FIG. 1. In some implementation, gathering data 200 may include capturing data of an event 202, including environmental data 204, for generating a 3D environment of an event and subject data 206 corresponding to a subject of the event (in this case, a man with a ball). Data for the event may be gathered by a number of different sources, including drones 212, observers 214, and external cameras 216. This data may be provided to the 3D timeline reconstruction system 100, such as by the data input module 102 as shown in FIG. 1. In some implementations, the gathered data is organized by type, for example, sensed data 220, 3D modeling data 222, photos 224, video 226, a written or verbal description 228, and data from a form or report 230. In some implementations, sensed data 220 may be generated by a sensor such as a light sensor, thermometer, accelerometer, or other type of sensor. 3D modeling data 222 may be generated by a 3D modeling program on a computer. Photos 224 may be generated by cameras such as on a cellphone, traffic camera, security camera, or other type of camera. Video 226 may be generated by these same type of cameras. A written or verbal description 228 may come from a witness or bystander of the event and may be collected by an insurance agent or law enforcement agent. A form or report 230 may also be collected from a witness or bystander of the event, and may be generated in written or electronic form. Combinations of different data types may be used by the timeline reconstruction system 100 to create a realistic and detailed reconstruction of the event.

In some implementations, gathering data 200 may include environmental data for an event, such as lighting data 232, weather data 234, and traffic congestion data 236. In some implementations, lighting data 232 may be data collected by light sensors, cameras, or weather sensors and may provide information about lighting conditions during the event. Weather data may include measurements of temperature, humidity, wind speed, precipitation, visibility, and other types of weather information collected by sensors during the event. Traffic congestion data 236 may be collected from traffic cameras, road sensors, or other traffic observation equipment and may include measurements of the amount of traffic passing through a particular area during the event. In one example, the timeline reconstruction of the event 202 may include lighting data for a partially sunny day at 5 pm with fair weather and light traffic congestion.

In some implementations, the timeline reconstruction system 100 may be used to extra metadata 214 from the environmental data (e.g., lighting data 232, weather data 234, and/or congestion data 236) for an event. The extracted metadata may include basic information that can be applied to a basic 3D model to create a detailed 3D environment for the timeline reconstruction.

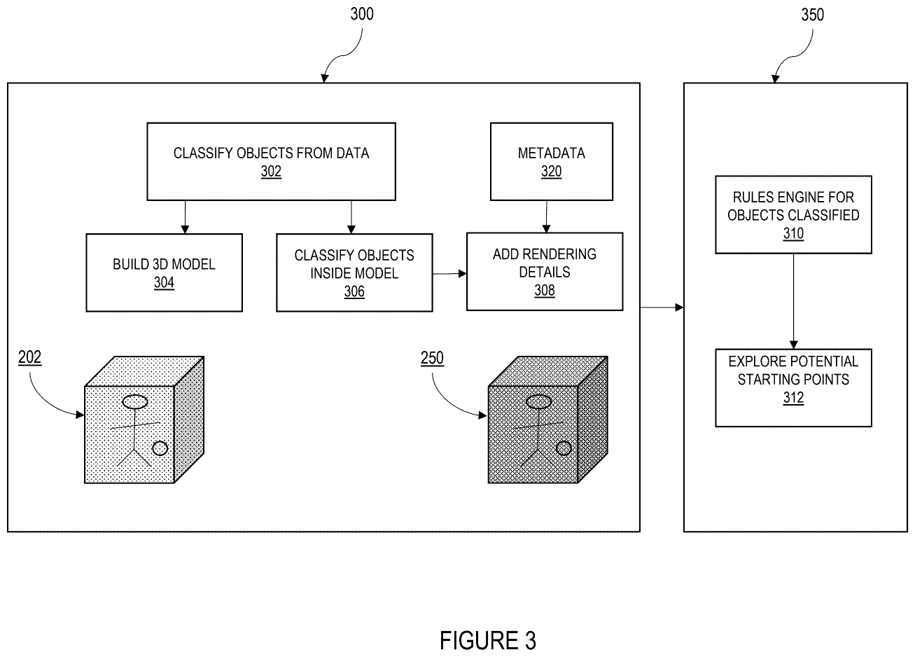

In some implementations, the timeline reconstruction system 100 may use aspects of gathering data 200 in FIG. 2 in classify objects 300, 350 from the gathered data and generating a detailed 3D model, as shown in FIG. 3. The objects may include objects in the environment such as buildings, roads, vegetation, infrastructure, vehicles, as well as people, animals, and smaller objects. For example, for an event happening in a neighborhood, the system 100 may classify data from a drone flyover as aspects of the event environment, such as sidewalks, curbs, streets, and houses, as well as detailed data for a woman holding a cellphone. This classified data may be used in a step 304 to build a 3D model of the event. This 3D model may recreate the event in a realistic, understood manner. In some implementations, the classification of objects from data includes forming shapes within the 3D background. Further, the timeline reconstruction system 100 may be used to carry out a step 306 to classify objects inside the 3D model. In the example above, data for an event may be processed to classify more detailed objects in the 3D model, such as trees, shrubs, people, vehicles, mailboxes, and street lamps.

In some implementations, the timeline reconstruction system may add the metadata 214 extracted from the event data to carry out a step 308 to add rendering details to the 3D model 202. In some implementations, the 3D model 202 includes basic shapes such as polygons to depict objects. The metadata 214 may be used to add detail to these basic shapes, thereby creating a detailed 3D model 250. These details may include texturing, lighting, shading, weather effects, surface friction, potential mass or weight, top speed, and adding small details to the objects of the 3D model 202 to create the 3D model 250 that is more accurate and life-like. Metadata can also include information on traffic congestion that can be used to visualize how busy an area is during a timeline reconstruction. Further, metadata can be used to classify objects within the timeline reconstruction. For example, metadata extracted from event data may include the weight of a car, which can in turn be used to classify a car type or model (for example a Chevrolet Camaro versus a Chevrolet Corvette).

Once the 3D model has been furnished with metadata 214, the timeline reconstruction system 100 may be used to carry out a step 310 to apply rules to the classified object data. For example, physics rules may be added to the detailed 3D model to provide a realistic visualization of the scene. In some implementations, these rules are added by the rules engine 110 of the timeline reconstruction system. In some cases, the applied rules may result in the modification of some aspects of the detailed 3D model to ensure that the data conforms to the rules used. For instance, in the above example, the speed of a car passing by on the street may be adjusted to conform to the laws of physics. In another example, if metadata includes information that it was raining the night before an event, the variables corresponding to friction on the road in the timeline reconstruction may be updated to account for wet (and therefore slicker) pavement. The rules engine 110 may also be used to generate object consistency rules within the timeline reconstruction so as to avoid objects behaving in an unnatural or unexpected way. This may include setting upper and lower thresholds for variables including object velocity, acceleration, mass, G forces, pressure, etc. that correspond to natural laws of physics. Further, the rules engine 110 may be used to update the structure and texture of objects in the timeline reconstruction after certain events, such as collisions. For example, if two cars collide with each other, the rules engine 110 may generate data to update the car models with deformed bumpers and dented textures where the collision occurred. This may include updating variables of sub-components of objects (such as the bumper of a car) to reshape or retexture the affected areas. It can also include updating the physical properties of an object (such as a car traveling more slowly after a tire is deflated).

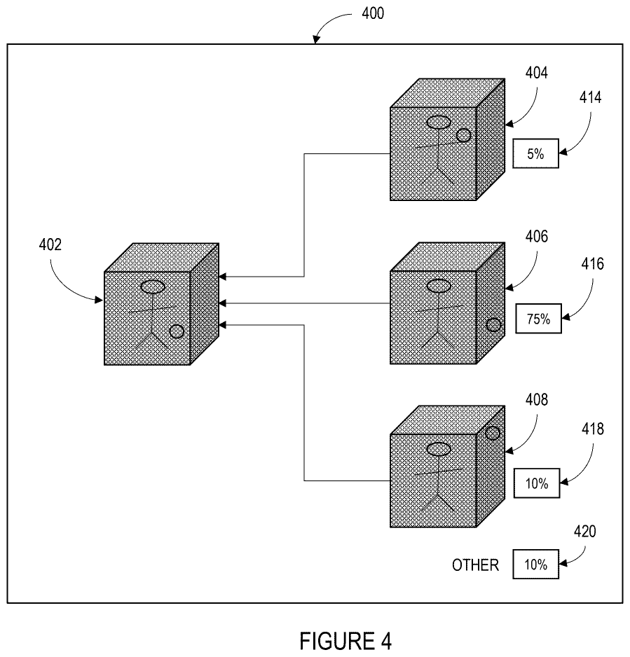

In some implementations, the timeline reconstruction system 100 may use aspects of classifying objects 300, 350 and generating a 3D model in FIG. 3 to further to explore different points along the timeline of the event in step 312. For example, FIG. 4 illustrates an endpoint 402 of a 3D timeline reconstruction 400 that includes a detailed 3D environment and a subject (in this example, a man with a ball at his foot). The 3D timeline reconstruction 400 may include three different possible starting points 404, 406, 408. These starting points 404, 406, 408 may be generated using machine learning (such as by the machine-learning module 108) based on gathered and processed data of the event. In the example of FIG. 4, the first possible starting point 404 depicts the man holding the ball, the second possible starting point 404 depicts the ball being rolled to the man, and the third possible starting point 408 depicts the ball being thrown to the man.

In some implementations, a confidence score may be generated for each of the possible starting points 404, 406, 408 based on a likelihood that each of the possible starting points are the correct starting point for the event. These confidence scores may be displayed in the 3D timeline reconstruction 400 with each of the possible starting points 404, 406, 408. For example, the confidence scores may be displayed in a callout box 414, 416, 418 next to each possible starting point 404, 406, 408. In the example of FIG. 4, the confidence scores for each of the starting points 404, 406, 408 are 5%, 75%, and 10% respectively, meaning that the second possible starting point 406 is the most likely to be correct. The displayed confidence score may facilitate a quick understanding of the event and likelihood of each scenario. In some implementations, the 3D timeline reconstruction 400 may include a confidence score 420 for a possible starting point that is not shown. In the example of FIG. 4, the 3D timeline reconstruction 400 displays a confidence score of 10%, indicating that the displayed possible starting points 404, 406, 408 are incorrect and another possible starting point is the correct starting point. This may help a user to understand the likelihood of unexplained phenomena in the event.

In some implementations, starting points 404, 406, 408 are shown in order to a user based on the confidence scores 414, 416, 418. For example, the starting point 406 may be shown to a user first, followed by starting point 404 and 408. This may allow a user to most efficiently view events in the timeline and explore variations after getting a general sense of the event.

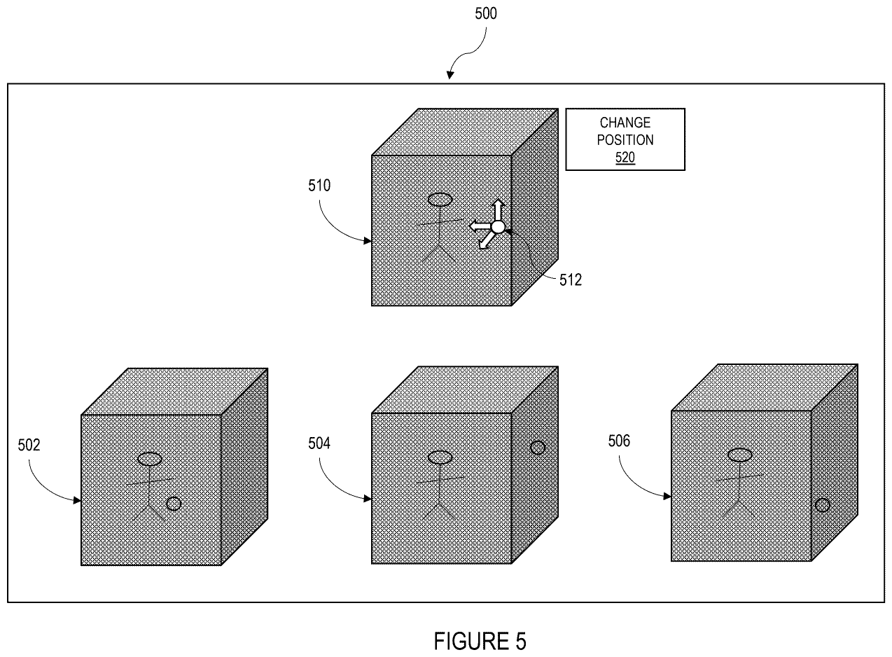

FIG. 5 depicts features of the 3D timeline reconstruction 500, according to one or more embodiments. In some implementations, the 3D timeline reconstruction 500 includes a “sandbox” feature that allows a user to change variables in the 3D timeline reconstruction 500, and then view the resulting visualization as a result of the changes. For example, the 3D timeline reconstruction 500 may include a starting point 502, which may include a subject (man with a ball at his foot) in an 3D environment at a first time. The 3D timeline reconstruction 500 may include various tools allowing a user to change variables within the 3D timeline reconstruction 500. For example, a tool 520 may be provided to the user to change the position of an object in the 3D timeline reconstruction 500. In the example of FIG. 5, the tool 520 allows the user to change the position of the ball within 3D space, resulting in the ball being moved farther away from the man (and placed at a higher elevation) in a mid-point 504 at a second time. This change may result in a new end point 506 in the 3D timeline reconstruction 500, which may indicate that the ball is far away from the man. In some implementations, the 3D timeline reconstruction 500 may alert a user to the existence of different end points in the timeline based on the changes.

Other tools may also be provided that allow the user to change parameters of the 3D timeline reconstruction 500. For example, a tool may be provided to enter a new object into the 3D timeline reconstruction 500, such as a cat playing with the ball. Other tools may also be provided that allow the user to remove objects, adjust lighting, change the weather during an event, change the timing of actions, change the shape of objects, and adjusting audio levels, as well as other adjustments to the 3D timeline reconstruction 500. The 3D timeline reconstruction 500 may be automatically updated after input from the tool, such that the user can see the results of the change, including new possible starting points, end points, or mid points on the timeline.

### EXEMPLARY 3D TIMELINE RECONSTRUCTION FLOWCHART

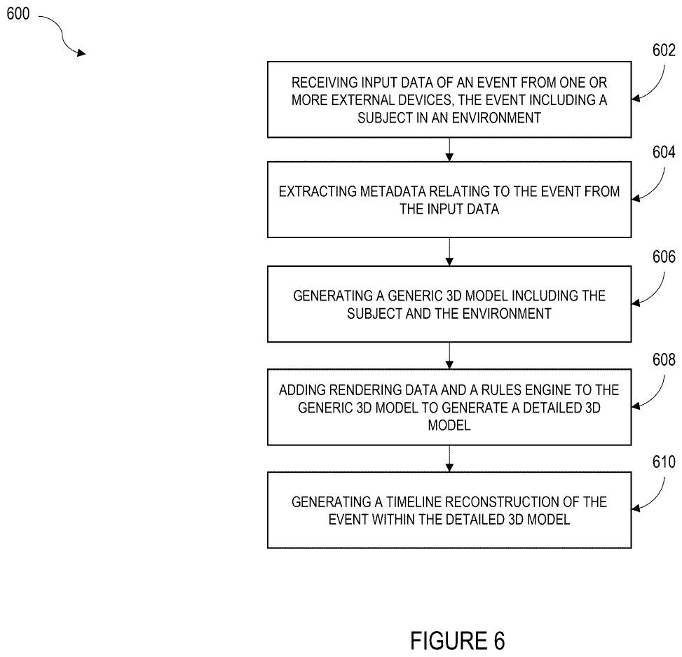

FIG. 6 is an exemplary flowchart of a computer-implemented or computer-based process 600 for generating and displaying a 3D timeline reconstruction of an event, according to one or more embodiments. In some implementations, the computing system 101 of the 3D timeline reconstruction system 100 and/or any of the modules 102-114 may perform one or more portions of the process 600 and are implemented using, for instance, a chip set including a processor (e.g., processor 106) and a memory (e.g., memory 104), as shown in FIG. 1. As such, the computing system 101 and/or any of modules 102-114 may be configured to facilitate accomplishing various parts of the process 600, as well as accomplishing embodiments of other processes described herein in conjunction with other components of the computing system 101. Although the process 600 is illustrated and described as a sequence of actions, operations, and/or functionality, it is contemplated that various embodiments of the process 600 may be performed in any order or combination and need not include all of the illustrated actions, operations, and/or functionality.

In block 602, the process 600 begins with receiving input data of an event from one or more external devices, the event including a subject and an environment. The event may be any type of event where an outcome can reasonably be inferred. In some implementations, data of the event is captured by external devices. This data may include visual data such as 3D modeling data, personal photos, dashcam footage, or external camera footage, text data such as a personal description of the event, police reports, and text information extracted from visual inputs. The data of the event may be captured by various devices, including cellphone cameras, traffic cameras, security cameras, weather sensors, vehicle sensors, databases, reports, interviews, statements, and combinations of these data sources. Data of the event is input into the 3D timeline reconstruction system 100, such as being received by the data input module 102 of the 3D timeline reconstruction system 100.

In block 604, the process 600 may include extracting metadata relating to the event from the input data. This step may include processing the data, for example, by the processor 106 of the 3D timeline reconstruction, as well as organizing the data by type and identifying potential missing data from an event. For example, an event may be a car crash. Data from the car crash may be gathered by various sources and input into the 3D timeline reconstruction system 100. This data may include visual data of car damage from debris, visual data of car damage, and footage from a camera mounted in an intersection. The data may be processed by the 3D timeline reconstruction system 100 which may identify missing data from a particular angle of the car crash. Metadata may be extracted from the analyzed data. For example, time and location data may be extracted from images, an overhead or satellite view may be used to establish a basic layout of the event, weather history for the location of the event may be established, a sunlight level may be extracted, and other visual details of an event may be extracted (such as car color, tint levels on glass, tire tracks, and other details).

In block 606, the process 600 may include generating a generic 3D model including the subject and the environment. In some implementations, the generic 3D model is generated with the received input data from block 602. This may include utilizing one or more trained machine-learning models to generate a basic 3D model and classifying objects in the environment. Objects in the 3D model may be individually classified, such as a bike or car. Objects in the 3D model may also be configured so that users may interact with the objects, such that a user may select, edit, and move each object. A machine-learning model may receive the event data as input, and then generate/output the 3D model using extrapolated data from an event. For example, the machine-learning model may receive a photograph, modify the photograph to create visual data from the photograph, and then analyze the visual data to create a 3D model of a subject within the photograph. In some implementations, the basic 3D model is generated with basic shapes such as polygons to depict objects. In some implementations, missing data may be extrapolated using one or more machine-learning models, for example by machine-learning module 108 of the 3D timeline reconstruction system 100. For example, the machine-learning module 108 may determine the initial position of a car before a car crash based on photographs taken after the crash, skid marks (e.g., received from one or more drones), and speed information from the car (e.g., received from one or more car sensors).

In block 608, the process 600 may include adding rendering data and a rules engine to the generic 3D model to generate a detailed 3D model. In some implementations, the rendering data is based on the extracted metadata related to the event. The metadata may be used to add detail to basic shapes in the generic 3D model, thereby creating a detailed 3D model 250. These details may include texturing, lighting, shading, weather effects, and adding small details to the objects of the generic 3D model to create the detailed 3D model that is more accurate and life-like.

Rules may also be applied to the data of the generic 3D model in this block 608. For example, physics rules may be added to the detailed 3D model to provide a realistic visualization of the scene. In some implementations, these rules are added by the rules engine 110 of the timeline reconstruction system. In some cases, the applied rules may result in the modification of some aspects of the detailed 3D model to ensure that the data conforms to the rules used. For instance, in the above example, the speed of a car passing by on the street may be adjusted to conform to the laws of physics.

In block 610, the process 600 may include generating a timeline reconstruction of the event within the detailed 3D model. The timeline reconstruction may show the location and position of various objects within the 3D model over a certain amount of time. The timeline reconstruction may show specific times (such as a start point, mid point, and end point) as well as transitions between the various specific times. In some implementations, a machine-learning model may receive the timelines and the rules engine, and then generate a 3D timeline reconstruction based on the timelines and the rules engine. The machine-learning model may generate the 3D timeline reconstruction such that each second in time of the 3D timeline reconstruction is created based on the previous second, and alters the 3D environment slightly. Since all objects in the 3D environment have been classified, the application of the rules engine may be used to generate smooth and accurate transitions of objects from one moment to another. In one implementation, the initial 3D timeline reconstruction has a duration of about 60 seconds. In other implementations, the 3D model may be pruned to generate longer and more detailed timelines.

In some implementations, the 3D timeline reconstruction system 100 may be used to create an interactive environment 3D environment. The user may be able to view various aspects of the 3D environment and timeline. For example, the user may be able to view multiple angles of the 3D timeline reconstruction, as well as viewing anchored 2D views from various angles. At these angles, the 3D timeline reconstruction system may allow an immersed user to query or change various objects in the scene, such as querying the identity of various actors in the scene or changing the actor's position. A user may also be able to view the 3D environment in an immersive way, such as by using Augmented Reality (AR) or Virtual Reality (VR).

In some implementations, the 3D timeline reconstruction system 100 includes a timeline reconstruction replay tool. This tool may allow a user to replay certain portions of the 3D timeline reconstruction. In some implementations, the timeline reconstruction replay tool is configured to display a first state of the subject within the environment in the detailed 3D model at a first time period, a second state of the subject within the environment in the detailed 3D model at the second time period, and a transition period visually depicting a change between the first state at the first time period and the second state ant the second time period. For example, the timeline reconstruction replay tool may display a man exiting a car at a first time and a man entering a house a second time (i.e., 20 seconds after the first time). The timeline reconstruction replay tool may be used to show the transition between the two actions (i.e., the man walking from the car to the house).

The timeline reconstruction replay tool may also be used to show a third state of the subject the second time period. For example, two separate timelines may be produced in the 3D timeline reconstruction system 100, a first timeline with the man entering the house after existing the car, and a second timeline crossing the street after exiting the car. Transitions may be shown on each of these alternative timelines, as well as a confidence score showing a likelihood that the timeline happened during the event.

In another example, an event reconstruction may be provided with a car crash as an endpoint and the system may generate the 3D model with a timeline including two starting points, where one starting point may include a car swerving to avoid a squirrel and the second starting point may include a car losing control on ice. In some implementations, a user may view all events along each of the timelines independently. In some implementations, the system (e.g., using one or more machine-learning models) may assign one or more starting points, mid points, or end points in the 3D timeline reconstruction based on a likelihood that the points occurred in the event. These confidence scores may be used to rank various starting points, mid points, and end points, such as displaying them to the user in order of the confidence scores.

The interactive 3D timeline reconstruction may include a “sandbox” mode that allows the user to directly control objects in the 3D environment. This interactive environment may include tools to allow the user to change variables in the 3D timeline reconstruction and view the result of the changes. These tools may allow for changing the position of objects, removing objects, adjusting lighting, changing the weather during an event, changing the timing of actions, changing the shape of objects, and adjusting audio levels, as well as other adjustments to the 3D timeline reconstruction 500. The 3D timeline reconstruction 500 may be automatically updated after input from the tool, such that the user can see the results of the change, including new possible starting points, end points, or mid points on the timeline. In some implementations, a user may be provided with a subject edit tool that allows the user to physically move the subject in the 3D timeline reconstruction. For example, a user may change the position of a man in the 3D timeline reconstruction from inside a car to on a sidewalk. The 3D timeline reconstruction may be automatically updated after this move, such as placing the car where the man was previously positioned to a parked position. This tool may allow the user to compare possible changes in an event due to the position of subjects.

### ADDITIONAL CONSIDERATIONS

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean...” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for reconstructing an event timeline, the computer-implemented method comprising:
receiving, by the one or more processors, input data of an event from one or more external devices, the event including a subject in an environment;
analyzing, by the one or more processors, the input data of the event including extracting metadata relating to the event from the input data;
generating, by the one or more processors, a generic 3D model including the subject and the environment;
adding, by the one or more processors, rendering data and a rules engine to the generic 3D model to generate a detailed 3D model, the rendering data based on the extracted metadata related to the event; and
generating, by the one or more processors, a timeline reconstruction of the event within the detailed 3D model, the timeline reconstruction comprising at least a first state of the subject within the environment at a first time and a second state of the subject within the environment at a second time, wherein the first time is different than the first time.

2. The computer-implemented method of claim 1, further comprising:
providing, by the one or more processors, a timeline reconstruction replay tool to a user, wherein the timeline reconstruction replay tool is configured to display:
the first state of the subject within the environment in the detailed 3D model at the first time period,
the second state of the subject within the environment in the detailed 3D model at the second time period, and
a transition period visually depicting a change between the first state at the first time period and the second state at the second time period.

3. The computer-implemented method of claim 1, wherein the timeline reconstruction further comprises a third state of the subject within the environment at the second time.

4. The computer-implemented method of claim 3, further comprising:
providing, by the one or more processors, a timeline reconstruction replay tool to a user, wherein the timeline reconstruction replay tool is configured to display:
the first state of the subject within the environment in the detailed 3D model at the first time period,
the second state of the subject within the environment in the detailed 3D model at the second time period,
the third state of the subject within the environment in the detailed 3D model at the second time period,
a first transition period visually depicting a first transition period visually depicting a change between the first state at the first time period and the second state at the second time period, and
a second transition period visually depicting a first transition period visually depicting a change between the first state at the first time period and the third state at the second time period.

5. The computer-implemented method of claim 4, wherein the timeline reconstruction replay tool is further configured to display a first confidence score for the second state and a second confidence score for the third state.

6. The computer-implemented method of claim 4, wherein the timeline reconstruction replay tool further includes a variable input tool, the variable input tool configured to receive data for at least one parameter of the event and adjust the detailed 3D model based on the at least one parameter.

7. The computer-implemented method of claim 1, wherein the input data of the event comprises one or more photos, video clips, verbal description, written reports, or 3D model data.

8. The computer-implemented method of claim 1, wherein the input data comprises one or more of lighting data, weather data, or traffic congestion data.

9. A computer system for visualizing an event timeline, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving input data of the event with a subject from one or more external devices;
generating a 3D model based on the received input data including the subject and the environment;
generating a timeline of the event within the 3D model, the timeline comprising a first time and a second time; and
a display device configured to display the 3D model, the timeline with the first time and the second time, and a tool for selecting a third time between the first time and the second time.

10. The computer system of claim 9, wherein the display device is further configured to display a confidence score based on a likelihood that the second time shows correct data.

11. The computer system of claim 9, wherein the display device is further configured to display a variable input tool, the variable input tool configured to receive data for at least one parameter of the event and adjust the detailed 3D model based on the at least one parameter.

12. A non-transitory computer-readable medium containing instructions for reconstructing the timeline of an event, the instructions comprising:
receiving, by the one or more processors, input data of the event from one or more external devices, the event including a subject in an environment;
extracting, by the one or more processors, metadata relating to the event from the input data;
generating, by the one or more processors, a generic 3D model including the subject and the environment;
adding, by the one or more processors, rendering data and a rules engine to the generic 3D model to generate a detailed 3D model, the rendering data based on the extracted metadata related to the event;
generating, by the one or more processors, a timeline reconstruction of the event within the detailed 3D model, the timeline reconstruction comprising at least a first state of the subject within the environment at a first time and a second state of the subject within the environment at a second time, wherein the first time is different than the first time; and
outputting, by the one or more processors, the timeline reconstruction of the event within the detailed 3D model to a user interface of a user device.

13. The non-transitory computer-readable medium of claim 12, further comprising:
displaying, by the one or more processors,, a timeline reconstruction replay tool to the user device, the timeline reconstruction replay tool configured to display:
a first state of the subject within the environment in the detailed 3D model at the first time period,
a second state of the subject within the environment in the detailed 3D model at the second time period, and
a transition period visually depicting a change between the first state at the first time period and the second state at the second time period.

14. The non-transitory computer-readable medium of claim 12, wherein the timeline reconstruction further comprises a third state of the subject within the environment at the second time.

15. The computer system of claim 14, further comprising:
displaying, by the one or more processors, a timeline reconstruction replay tool to the user device, the timeline reconstruction replay tool configured to display:
the first state of the subject within the environment in the detailed 3D model at the first time period,
the second state of the subject within the environment in the detailed 3D model at the second time period,
the third state of the subject within the environment in the detailed 3D model at the second time period,
a first transition period visually depicting a first transition period visually depicting a change between the first state at the first time period and the second state at the second time period, and
a second transition period visually depicting a first transition period visually depicting a change between the first state at the first time period and the third state at the second time period.

16. The computer system of claim 15, wherein the timeline reconstruction replay tool is further configured to display a first confidence score for the second state and a second confidence score for the third state.

17. The computer system of claim 15, wherein the timeline reconstruction replay tool further includes a variable input tool, the variable input tool configured to receive data for at least one parameter of the event and adjust the detailed 3D model based on the at least one parameter.

18. The computer system of claim 12, wherein the input data of the event comprises one or more photos, video clips, verbal description, written reports, or 3D model data.

19. The computer system of claim 12, wherein the input data comprises one or more of lighting data, weather data, or traffic congestion data.

20. The computer system of claim 12, further comprising:
displaying, by the one or more processors, a subject edit tool to the user device, wherein the subject edit tool is configured to edit the position of the subject within the detailed 3D model.
